(19) United States
(12) Patent Application Publication
(10) Pub. No.: US 2005/0047580 A1
(43) Pub. Date: Mar. 3, 2005

(54) Mnemonic techniques on a soft-phone and a single point of contact service

(76) Inventors: John Beck Mow, Frisco, TX (US); Raymond J. Sheppard, Springhill, FL (US)

Correspondence Address: John Beck Mow, 4665 Glen Heather Dr., Frisco, TX, 75034, US

(21) Appl. No.: 10/929,813

(22) Filed: Aug. 30, 2004

Related U.S. Application Data
(60) Provisional application No. 60/499,416, filed on Aug. 30, 2003.

(51) Int. Cl. H04L 12/66

(52) U.S. Cl. 379/265.09

(57) ABSTRACT

A method of providing a single point of contact, subscription and permission based multi-media communication service, a unique tracking and incentive methodology for marketing companies, and provisions for sponsored services and advertising to the subscribers is described. A software module, referred to as the Communication Assistant (CA), is loaded into a subscriber's computer or mobile device that uses soft-phone based enhanced mnemonic command and control tools to enable easier ways of communicating with multi-media forms of communications on the Internet or the PSTN, cellular, WIFI, etc. type of networks. Subscriber affinity groups may be formed with synchronization of communications, electronic genealogy trees and database updating. Multiple marketing opportunities utilizing the ability of the computer and adjunct program rules determination can be combined with the soft-phone.

### BACKGROUND OF THE INVENTION

□

The information age has matured tremendously with the advent of voice mail, email, fax, wireless phones, wireless messaging, low long distance rates, the Internet and the incredible shrinking price of almost every piece of electronic equipment in the commercial marketplace. Virtually every business in the U.S. uses most of these methods of communications, with the Internet possibly being the least used among smaller businesses depending upon their communication needs. But with the lowering Internet access rates falling, even these companies are seeing the advent of being connected to the eCommerce world.

□

Large retail and commercial companies are linking all of their locations together over the Internet or virtual private networks (VPN) for many reasons. Telephone systems are being released that utilize the Internet IP voice protocol bypassing the local telephone companies that charges more per month for one voice grade telephone line, i.e. about $40 per month, than a broadband DSL access line available from a plethora of companies that averages between $29-$49 per month with speeds that can have 6 or more voice circuits combined with data in a Voice over IP (VOIP) configuration. □

There are many hardware/software offerings that are bypassing the expensive PSTN network. The PSTN has been the backbone of growth for this country, but whose architecture cannot support the explosion of data now that PCs are doubling in speeds virtually every 2 years and can easily manage high speed links, such as websites and downloaded files and documents. Once a broadband access, DSL or T-1, to the Internet or VPN has been obtained by two users anywhere on the network, they can talk using a PC microphone and speaker using VOIP from a number of free sources that provide a “softswitch” to conduct this process. The digital sampling is performed via software in the PC whereas in the PSTN it is done via a hardware chip in a digital phone or in a line card or channel bank at the customer's premise or in the central office.

□

Softswitch is the generic name for a new approach to telephony switching that has the potential to address all the shortcomings of traditional local-exchange switches. The softswitch is where all the service intelligence resides for the delivery of local telephone services. Softswitch technology solutions can lower the cost of local-exchange switching, present the method to create differentiated local telephony services, and ease the migration of networks to support packet voice end-to-end.

□

Packetized voice involves the digitizing, compressing, and dividing of voice into packets. These packets can then be sent via various routes, to the receiver, whereupon they are reassembled. Softswitch, media gateway controller, call agent, gatekeeper are the varied nomenclatures that have been attached to the products that perform the functions that are coming to be called softswitches.

□

All forms of communications can be converted to digital signals to be sent over the Internet or VPNs, over wireless networks and to wireless instruments. □

The business person finds themselves having a multiplicity of communication devices to fit their needs, i.e. a home telephone number or two, an office number or two, a wireless number for work and possibly one for personal use, and a pager and fax number or two. Business cards have more numbers on them than words. People have to carry their paper or electronic organizers with them just to keep track of so many numbers. And if a business or personal move occurs, new business cards and everybody's organizers have to be changed accordingly. □

There have been many methods introduced in the past 10 to 15 years to help organize these forms of communications. Perhaps one of the most overlooked methodologies was introduced in 1989 from a company called Tele*Finity, which was a “One Number” system for all voice communications, voice mail and fax for subscribers. It was marketed under the name of Magic Number to many large organizations that had tens of thousands of subscribers. It was a combination of an IVR system and a large tandem switching system from Harris Communications. It provided out of band signaling between the switch and the voice response unit, being quite advanced at that point in time. It provided local and 800 access to the subscriber and a plethora of features to provide low cost long distance, find me features, stored voice mail, and the like on the PSTN. □It provided mnemonic dialing schemas to make it easier to use, especially for traveling personnel who used the system extensively.

The inventor of Magic Number was Raymond J. Sheppard who coauthors this patent. Mr. Sheppard never patented his ideas at that time. This concept was also introduced into the real estate world in 1992 for realtors who also employed live operators for messaging and communication purposes with their clients utilizing local Foreign Exchange or 800 access to their services of listing, selling and communicating with their buyers and sellers of homes. It supported over 800 offices and 4,000 agents for over ten years. □

Several One Number types of patents were obtained after Magic Number by: Access Communications Inc., Telephone control system with branch routing U.S. Pat. No. 5,375,161 (simple input/output routing predated on many switches in previous years).

One number, intelligent call processing system U.S. Pat. No. 5,588,037 (predated on a number of switches).

Adjunct controller for a telephone system U.S. Pat. No. 5,673,299 (predated on a number of switches).

Method and apparatus for processing telephone calls and delivering information about the calls to a pager U.S. Pat. No. 5,694,453 (processing calls and delivering information to a pager).

Telephone control system which connects a caller with a subscriber at a telephone address U.S. Pat. No. 5,752,191 (scheduled call times for subscribers).

Xantel Corporation One number, intelligent call processing system □U.S. Pat. No. 5,946,386□□ □ (a single computer answering for voice, data and fax call, not a network concept)□.

□Touch Tone Technologies Inc. Call processing system, method and computer program product □U.S. Pat. No. 6,088,437 □(Call Pullback method of attempting to reach callers).

MCI WorldCom, Inc. Virtual second line hybrid network communication system □U.S. Pat. No. 6,351,464 □(one number multiple outbound calling number attempts).

□Murex Securities, Ltd. One number, intelligent call processing system □U.S. Pat. No. 6,381,324 □(parallel vanity broadcasts).

North Coast Logic, Inc. Tele-management system with single point of entry application #20020054669 (controls PBXs, 911 and voice mail units).

Many fundamental functions of these patents were performed in part or in total by previous switching systems from the mid 1970”s and 1980”s, i.e. the WATSBOX from Action Communication Systems Inc., a PBX/Tandem from Danray which became part of Northern Telecom/Nortel, the Roadrunner Network System from Action/Honeywell Communications Network Division a corporate private tandem networking and IXC switching system, the Multi-Application Exchange from Advanced Business Communications Inc. which was an IXC and OSP switching system, and others. The features ran together as tandems, operator services, ACDs, PBXs and payphone features ran together.

The WATSBOX in 1975 by Action Communication Systems Inc. and its successor, the ROADRUNNER in 1980 by Action/Honeywell Communications Division, both utilized speed number abbreviated dialing and had voice recognition commands for dialing the destination number. The commands were both digits and location words, i.e. Office, Home, Secretary, Operator, etc. for speaker independent recognition. Mr. Mow, co-author of this patent, worked for the companies that developed the WATSBOX and the ROADRUNNER. Many other systems utilize these same techniques today.

None of these patents or ideas integrated the Internet, online VOIP, external network and messaging between two subscribers with a soft-phone as the fundamental element as this patent does in its initial claims. None utilized mnemonics as a simplified method of command and control. All utilize the NANP number dialing scheme except for speech recognition systems that sometimes utilized spoken names for easier calling.

There are several verities of soft-phones that can be purchased or downloaded on the Internet. They allow the user to perform Internet calls between similar users and to send and receive call from the PSTN network in select cities where the provider has gateway service. Some offer fax, email and voice mail services also but not to the extent or control manner described in the invention. □ All utilize the conventional ISO 12 key dial pad.

The invention in some ways is like a combination of a multi-level marketing structure and a mobile communications system with subscribers, guest-subscribers and non-subscribers, each with different privileges and permissions to do certain things achieving various results in the structure.

The subscriber can be viewed as a Master such that it can have peer Masters, sign up other Slave subscribers, give away sub-Slave subscriptions and possibly receive commissions on activities below them, all the while being able to have flexible, sponsored advertisements and infomercials. On the other hand, in the corporate world, there are no commissions, just the organizational chart structure. But the ability to have a flexible software and distribution structure based upon the fact that the CA can be sent to others with certain permissions and controls, creates a unique model of manageable building blocks that can be tailored to many standard and new business models, not only for communication purposes, but for revenue and commission incentive schemes. Advertisers can target particular categories and groups of individuals and know how many times the ads were displayed or heard based upon the soft-phone utilization record keeping.

If an organization such as an Internet carrier, wants to implement three levels of CA's, say a Master, Guest and Free levels, and allow any of them to recruit or sign up others, creating an undisciplined down-line organization, but one that is designed to get quantities of people using some form of the CA via broadband connections, the resulting tree structure can be governed by a set of rules to maximize several things. Advertising can be directed at certain levels, certain down-lines, certain geographical areas, peak users, etc.

Incentives for signing up new users can be structured creatively and automatically because the tree structure is linear, as one example. If someone terminates service, that space in the tree just gets eliminated and everything below moves up a notch.

Many other forms of structure and compensation plans can be created with the easy tracking and statistics of the CA's.

Soft-Phone Controls Using Mnemonics

Virtually all telephone keypads and soft-phone keypads look alike and only use 12 keys with the digits 0-9, * and #. To dial someone in this country, the 10-digit NANP schema is utilized unless some form of speed number is utilized. The claims outline a unique schema that utilizes mnemonic command and control functionality to make the entire process of dialing, sending a message, and other controls much easier. The entire soft-phone can change in size, shape, color, perspective, etc. based upon command utilization. Depending upon the state of the transaction, only certain keys may be utilized and can be highlighted, enhanced or whatever to make the steps simple for the user.

The command mnemonics may maintain the conventional number and lettering schema found in North America. For instance, the 2 key typically is shown as 2□^{ABC}□. The embodiment of the claims modifies this concept, and the key for “sending” a message becomes 7□^{SEND}□ instead of 7□^{PRS}. This is done so when the user is at another telephone anywhere in the country, calls into the service and wants to perform some control functions, the user will think in terms of this mnemonic schema, that jogs their memory, and the same keys are utilized.

The same rationale is maintained for dialing or sending something by “initials”. The initials can be any length and follow the mental thought patterns of how we remember names of people or groups. Thus mnemonics in this case, uses our naming convention of our minds rather than speed numbers or the 10-digit NANP to apply. We all can remember more names and initials than a list of numbers.

Along this line, having different levels of mnemonics for different skill levels of users is unique. A child using a soft-phone can have the phone configured in different ways to aid in the use. A computer-illiterate person may have very different command prompts and processes to make it easier to use the system. All of this can be automatically adjusted by determining the identity of the user through various schemas from logon to automatic biometrics.

The embodiment of the patent utilizes dynamic software to make computer processes easier by maximizing mnemonic controls for user interfaces.

Patents Researched

The application 20020164978 System and method for making telecommunication calls by Moskowitz, Paul Andrew; et al., lists dialing mnemonics but these have been utilized in the Magic Number telephone system as described herein over 10 years ago. Furthermore virtually every personalized long distance service for over 20 years has offered “speed numbers” or voice recognition where some combination of digits or words translate to a stored telephone number. □ The main difference between Moskowitz and this patent is that the mnemonic schemz herein is used for multiple command sequences in the service for multi-media communications, not just dialing a telephone number, to aid the subscriber in the command and control of the service whether on or off of the network. This invention changes the keypad to spell out the command on the label leading the user in the next-step-option. Moskowitz only talks about dialing a telephone number and translating that to a “phone address”, a technique that has been done before. Moskowitz's described technique of looking up the coded entry in a table is a common computer process in every computer. Their Independent claims 1, 6, 11, 12, 30, 31 appear obvious. How else does a computer work? Moskowitz further limits their technique to “ambiguous numbers” whereas this patent describes dialing, in the limited sense of a telephone number, by “initials or name” not in an ambiguous manner.

U.S. Pat. No. 5,619,563 Hsiao. Mnemonic number dialing plan utilizes mnemonics for foreign languages where phonetics are used because of the large number of letters or symbols in the alphabets. The mnemonic to be translated into a telephone number preferably consists of a phrase, where the number of words corresponds with the number of digits in the telephone number, and only the first phonic sound of a word in the mnemonic phrase is used in mnemonic dialing.

UNIFIED SERVICES Kurganov, Alexander; et al. 20010023400 Collectively functioning bundle of telephone and network services provided by one service provider to a user—local, cellular, voice mail, facsimile, etc. The patent does not provide these services but rather allows a user to contract individually with them and control them through the use of the patent enhancement.

SOFT-PHONE Miller, Kory Wade; et al. #20020122417 Selection of voice connection type from a soft-phone while connected to the PSTN, is a unique feature set not employed by this invention.

ADVERTISING Gupta □U.S. Pat. No. 5,333,186 □Telecommunication Call Billing Method And Apparatus discusses a service for callers that dial in and receive an “infomercial” but is not a subscription, online system.

Kamel U.S. Pat. No. 6,212,262 Method Of Performing Automatic Sales Transactions In An Advertiser-Sponsored Telephony System Jacobs, Paul E.; et al. 20040039642 E-mail software and method and system for distributing advertisements to client devices that have such e-mail software installed thereon, not performed by this invention.

AFFINITY NETWORKS & ELECTRONIC GENEALOGY Shell, et al. □□U.S. Pat. No. 6,415,265 □□□Multi-level marketing computer network server□□ □is not for creating or tracking an Electronic Subscriber ID as this invention employs.

### □SUMMARY OF INVENTION□

The CA a software based telecommunications application solution that may well revolutionize the way that many businesses, such as real estate agents, insurance agents and attorneys do business.

It□ □is a leading-edge, desktop software application that loads onto the user's PC. The CA alerts the user (subscriber) whenever a call or message is received and allows the user to both receive and respond to the call or message from any communications device the user has access to at the time—phone, PC, PDA, cell phone, etc. In turn, the subscriber is able to respond and communicate without changing their communications habits. The CA□ □makes communications simple, easy to use and efficient any time, any place and with any device the user has available at the time. No other service today can make this claim. With the CA, the command and control of all of the subscriber's communications and information remain with the user and are always available. On-line, all communications are in real time.

The CA provides a high-level, technology “dashboard” that enables the user to be in the business communications “driver's seat”. The CA places at the subscriber's fingertips, the ability to group and facilitate every type of business communication from voice to data, enabling any and all of the user's communications devices including landline phones, wireless phones, fax machines, PCs, laptops, and PDA's. As a result, the subscriber is never□ □out of reach with his or her customer base or personal contacts. The user is reachable and can reach anyone anywhere, any time, any place, with any communications device.

The CA is extremely easy to use and creates a simple “point and click” environment for the user and very little learning curve is required. The CA sits□ on top□ of other business applications such as WEB sites, PC Desktop, word processing or database programs or, for example, in the case of a realtor, even on mortgage loan sites. This allows the CA subscriber to have a virtual “one stop shop” for all of their business access requirements. The CA creates and provides a conduit between numerous business entities and information sources. As such, customers are provided with a long awaited, efficient and time-savings communication technology. The customer, who wants a command center for all of their business communications activities and something that is easy to use and cost effective, wants the CA. When the “Communications Assistant” recognizes that an Internet connection is present, The CA automatically performs basic housekeeping tasks, activities and updates based on the “rules” set by the user and the system's “learned” behavior patterns of the user.

For example, The CA can access and retrieve information and messages from the subscriber's favorite services e.g. Yahoo, Hotmail, AOL, e.g., etc. In the case of a realtor, for example, it will update the realtor's personal website with the current mortgage interest rates, update and, if desired, send MLS client and home property search information to a prospective client, process a CMA request or property profile and forward it to whomever the user selects. Phone calls, messages, and even identifying information from Caller ID can be automatically entered into a “contact profile”, including such information as name, address and phone number. Imagine the convenience of simply pressing a key or by saying “yes” to your Communications Assistant and the CA makes make this happen! The same Caller ID technology that the phone companies use is also used by the CA to automatically “look-up” the caller's name and address. Then, the CA will auto-fill and store the contact record in the subscriber's personal contacts database. This auto-fill function is an extremely convenient and a substantial time-saving feature for the user. □

The Communications Assistant may respond to any touch tone (phone), speech command (phone), or key command (on the Internet or PDA device) or computer keyboard or touch screen. Whenever the subscriber desires a more personal and “high touch” feature, the Communications Assistant will connect the (incoming) call to a live operator (The CA's Operator services). The subscriber need only press the “0 Oper” key on the phone touchpad or click “Customer Care” on the screen (when on the Internet) and the caller will be greeted by a trained, professional telephone receptionist. In addition to greeting callers in the subscriber's name (“Susie Smith's office, may we help you?”), the phone receptionist will respond to the caller according to the “rules” the user prescribes and will also manage calendar and coordinate and confirm appointment changes.

### BRIEF DESCRIPTION OF DRAWINGS

FIG. 1. Communication Assistant Diagram Internet, PSTN, Wireless Connection.

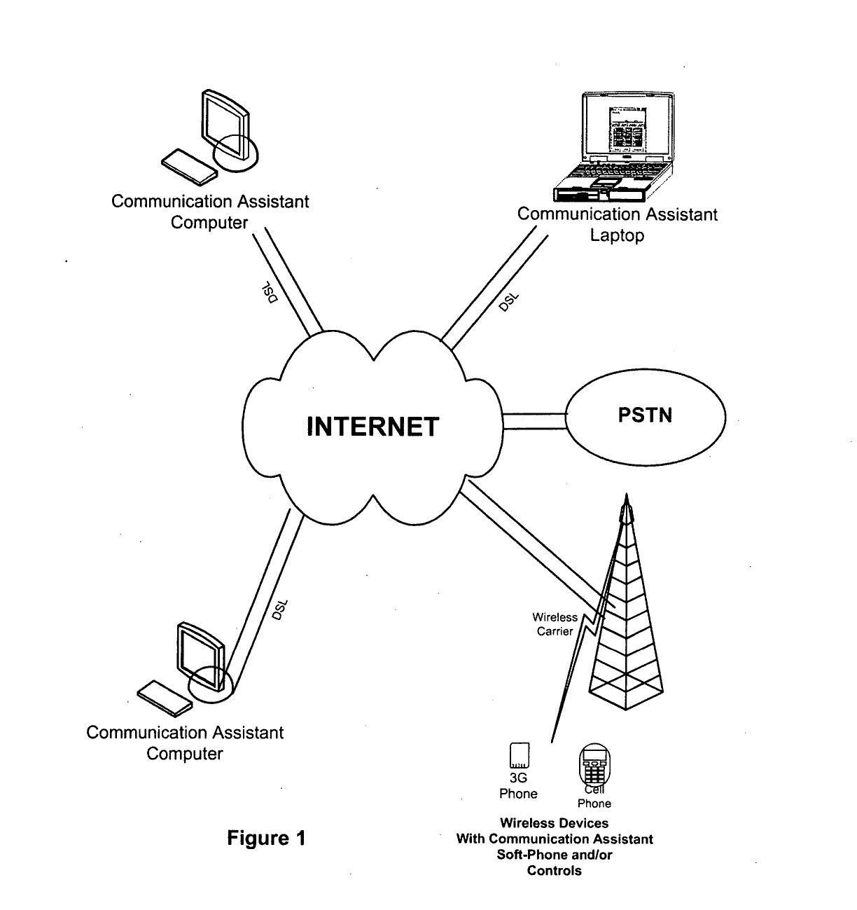

FIG. 2. Communication Assistant Soft-Phone. Shows sample soft-phone with display area, keypad and soft keys. Mnemonic concepts shown on keys for the ready state of the phone.

FIG. 3. Communication Assistant Soft-Phone. Shows advertising or promotions in display area and Microsoft Outlook linkage for contacts, calendar, etc.

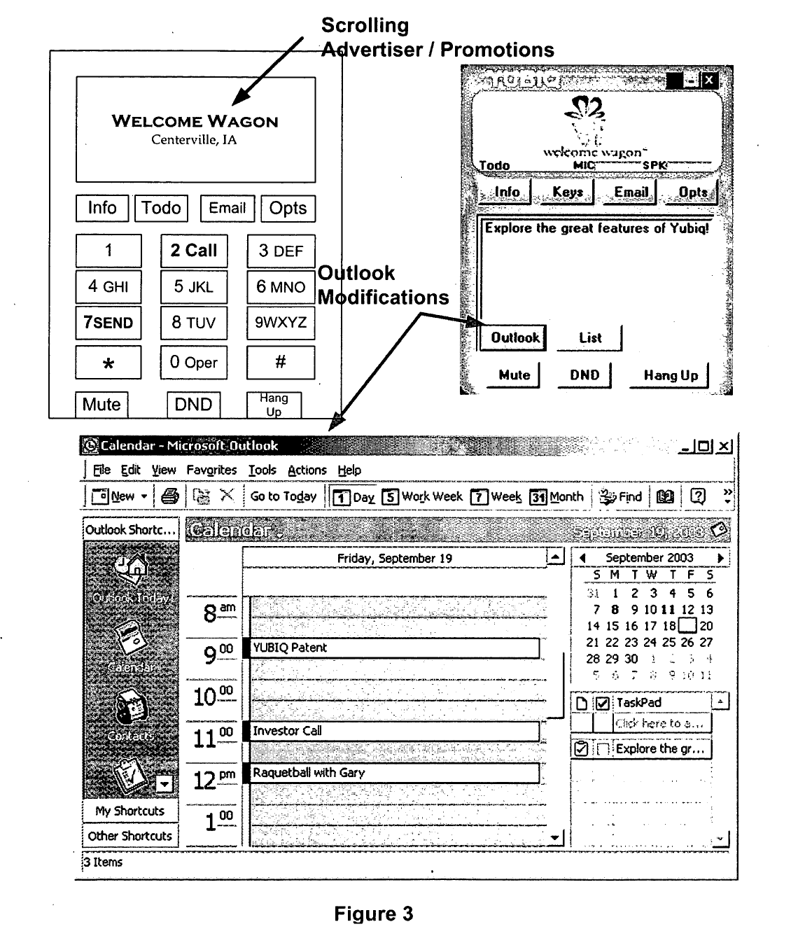

FIG. 4. Communication Assistant Soft-Phone Dynamic Keypad. Shows dialing sequence using mnemonic concepts.

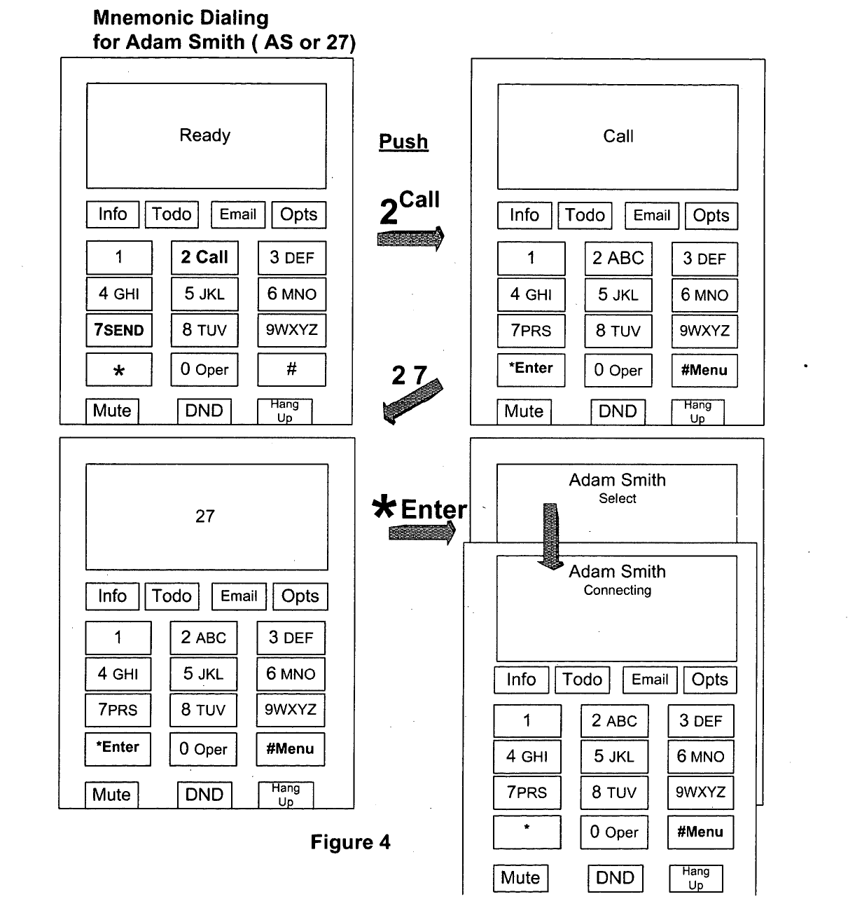

FIG. 5. Communication Assistant Soft-Phone Email. Shows mnemonics for sending an email. □

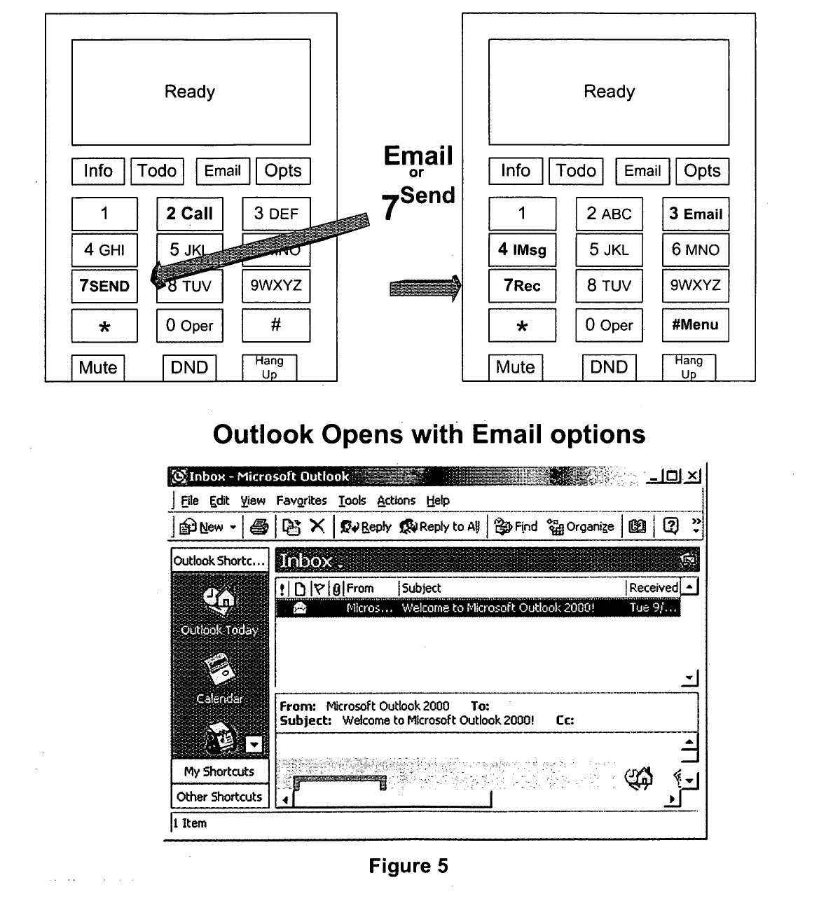

FIG. 6. Sample Electronic Genealogy Tree structure.

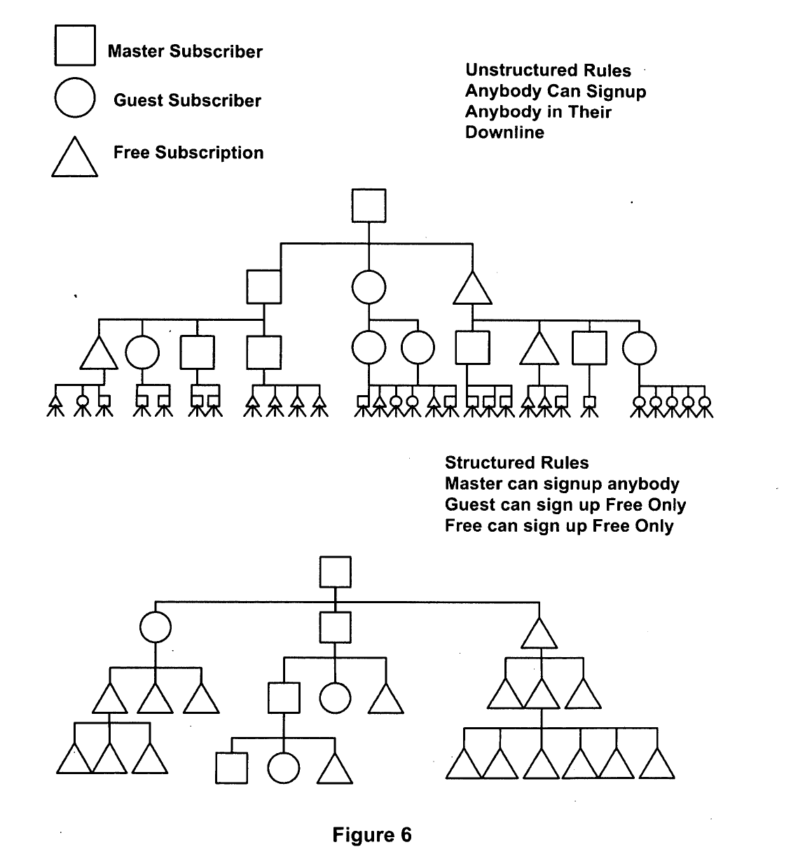

FIG. 7. Ready State of a Soft-Phone Dialing with CALL or SEND example of mnemonic dialing enhancements.

### DETAILED DESCRIPTION □

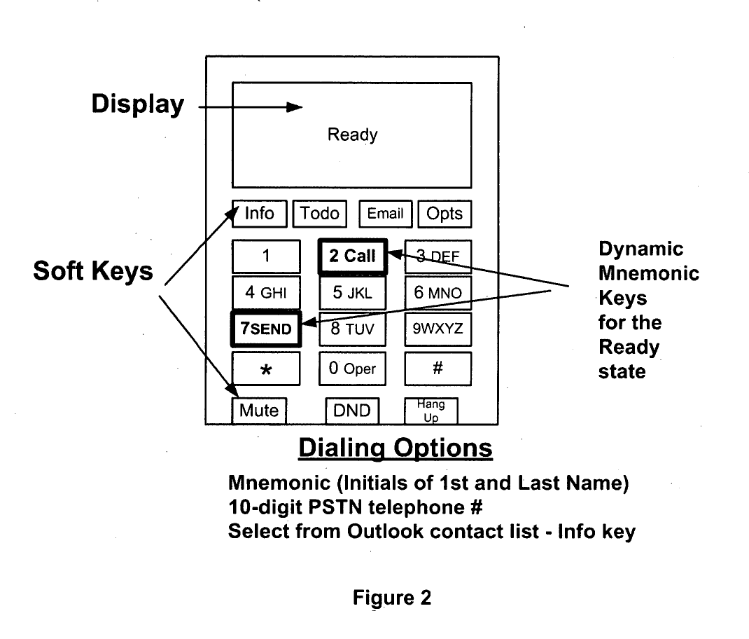

FIG. 2 shows a sample soft-phone drawn with a rectangular image that has an ISO keypad with conventional digits and letters on the 12 keys. There are other soft keys shown as Info, Todo, Email, Opts, Mute, DND, Hang Up. There is a Display area shown with the Ready state shown.

On the keys, the mnemonic dialing schema shows Call on the 2 key and Send on the 7 key. Call or Send can be invoked by the user as well as other administrative functions via the soft keys.

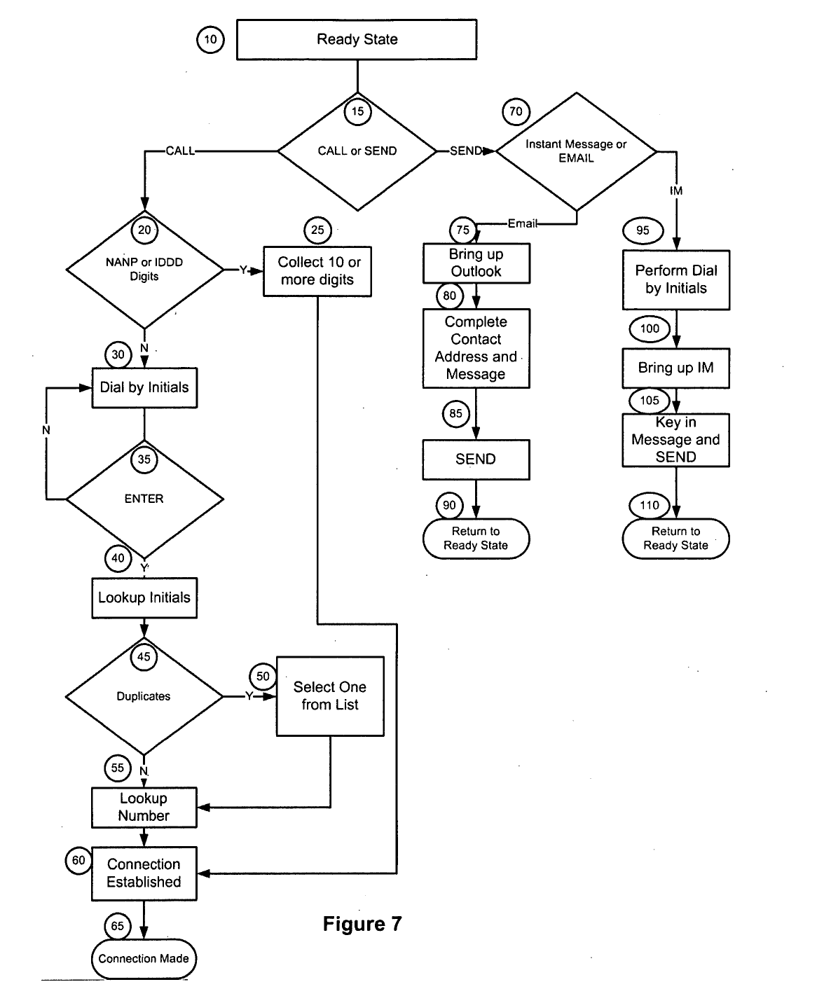

FIG. 7 starts at the Ready State 10. When CALL or SEND is selected 15, if CALL is selected 20, entering digits to be dialed is collected. If 10-digits or more are collected per the NANP or international dialing schemes, they are delivered to the ENTER function and dialed.

If Dial by Initials is followed 30, the digits are collected 35, ENTER is depressed, 40, any duplicates are resolved 45 to 50 and the desired one selected, the number is looked up 55 and the connection 60 is performed either over the Internet or the PSTN 65.

If SEND 15 is selected, the option of an Instant Message or EMAIL 70 is determined, among other options that may be available. Email 75 evokes bringing up Outlook 75. The standard Outlook process is followed 80 and sent 85, returning to the ready state 90.

If Instant Message is selected 70, 95 dialing is performed, 100 the IM message block is brought up, the message keyed in 105, sent, returning to the ready state 110.

Soft-Phone Used in Conjunction with Other Computer Programs

Because of the power of computers, the soft-phone can interact with another program which may precede or follow the user's use of contacting a party. For instance a soft-phone can be provided in a public arena in a shopping mall, for example, where if the user answers a quiz question concerning a local sponsor, the award may be that a call anywhere in the world can be awarded. Similarly, in a casino, if a player of a video casino game wins a particular prize, a soft-phone may appear allowing a free phone call, or vice versa, if the telephone at a casino is used to place a call, a free game may be awarded as a courtesy. There are unlimited possibilities having a soft-phone interacting with programs that are interconnected to a communication controller, are sponsored advertisers, or with programs that please the user for marketing purposes.

The foregoing description uses preferred embodiments and processes to illustrate the present invention but is not limited to these embodiments. Modifications may be made by those skilled in the art which differ from the specific details disclosed here, but which are still within the scope of the invention. □

1. AA method for improving the ease-of-use of a subscriber's command and control steps of a soft-phone on a computer on a data network, said method comprising employing a plurality of mnemonic techniques that more easily lead the user through the command steps utilizing enhanced soft-phone templates, keypad and key label modifications, providing a plurality of mnemonic dialing and addressing schemas to contact or send multi-media communications to a single party utilizing a short character address, and providing a plurality of mnemonic dialing and addressing schemas to contact or send communications to multiple parties using a short character address.

2. The method according to claim 1 with one example of a mnemonic technique being dialing or addressing a party or parties by their “initials or abbreviated name” via the soft-phone keypad, by keying in one or a combination of letters from a conventional ISO keypad, representing the initials or the name of the party or parties, such that at least one of a plurality of communications can be sent to the party or parties, with examples of the technique being “John Doe—with initials JD” being keyed as 53, “Bubba Ray Smith—with initials BRS” being keyed as 277, “Sales Force—with initials SF” being keyed as 73, “Service Personnel—SVC” being keyed as 782, and the like, and a method of resolving duplicate resultant numbers by making known the named options to the user in a plurality of ways to select the desired one.

3. The method according to claim 1 with another example of a mnemonic technique being one that changes the labels on the keys of the keypad in a plurality of ways such that the command options that are next available are displayed on the appropriate keys, such as the key label 2^{ABC} changes to 2□^{CALL} for the command state CALL or changes to 2^{ACCEPT} for the command state ACCEPT, 7^{PRS} changes to 7□^{SEND}□ for the command state SEND and the like, with another example of using the entire key label as a command being the 2^{ABC} key changes to CALL, the 7□^{PRS} key changes to SEND and the like.

4. The method according to claim 1 further implementing a particular level of ease-of-use techniques for a user, comprising the steps of determining the identity of the user in a plurality of ways including by logon, by biometric identification and the like, determining the assigned skill level of the user to be employed via an associated database or table parameter, said skill levels comprising children, parent, computer-illiterate, professional, and the like, modifying the technique to the skill level associated with the user, and applying said technique changes to the soft-phone.

5. AA service providing a single point of contact, subscription and permission based multi-media communications service utilizing a soft-phone on a computer on a data network, said network being connected to the PSTN, with multiple levels of subscribers and affinity groups, comprising the steps of using a 10-digit North American Numbering Plan or international standard telephone number as the single contact number to be called by other subscribers via their soft-phone and called by any party via the PSTN, in order to establish contact with the subscriber, providing a means of subscriber command and control access to the service via a soft-phone interface and via dialed DTMF digits over the PSTN, providing and displaying dynamically sponsored advertisements and promotions via the soft-phone in a plurality of formats, tabulating a plurality of advertiser statistics for measuring advertising effectiveness metrics, incorporating a plurality of mnemonic techniques for improving the ease-of-use of subscriber soft-phone commands and control by employing techniques that more easily lead the user through the command steps with enhanced keypad modifications, and dialing and addressing by a mnemonic schema to single or multiple parties.

6. The method according to claim 5 further comprising assigning a unique Electronic Soft-phone Identification (ESID) to a subscriber, said ESID containing a plurality of information parameters comprising the identity of the up-line subscriber and the affinity group that sponsors, assigns or sends the service to the subscriber, and the like, and including the ESID in the billing record of each service transaction allowing an electronic genealogy tree to be easily determined for a multiplicity of reasons comprising commission calculations, marketing/sales purposes, advertiser metrics purposes and the like.

7. The method according to claim 5 further comprising updating and notifying an affinity group's informational data, responsive to a modification of one subscriber's informational data, by enabling the notification of the modification to the corresponding informational data in every other subscriber's informational folder when they log-in.

8. The method according to claim 5 further comprising facilitating new and renewal subscriptions of a soft-phone service component by the means of offering a plurality of incentive and compensation plans on-the-fly to the subscribers as determined by a plurality of subscriber qualifying parameters, utilizing the soft-phone to deliver the communications to the subscriber.

9. The method according to claim 5 further comprising allowing the subscriber to select the style or model of the soft-phone they desire.

10. The method according to claim 5 further comprising allowing the sponsor to assign the style or model of the soft-phone to the subscriber.

11. The method according to claim 5 further comprising authorizing the sponsor to display certain permanent advertising techniques using the soft-phone for brand recognition in a plurality of ways such as by the model, color, labeling, unique shape and the like of the soft-phone.

12. The method according to claim 5 further incorporating a mnemonic technique for improving the ease-of-use of dial commands of a subscriber calling into their own number from the PSTN using DTMF tones from a conventional ISO telephone keypad, said method, after the service answers and user identification is established, comprising a single command word correlation to a digit key (as in claim 3), where to CALL a party is performed by dialing the digit “2” associating the first letter of the command CALL correlating to the key 2^{ABC}, the command SEND correlating to the key 7^{PRS} and the like.

13. An advanced method of utilizing a soft-phone on a computer on a network in conjunction and interaction with at least one of a plurality of different adjunct programs, comprising a plurality of permission rules being executed on the operation of the soft-phone after receiving an communication from said adjunct program or vice versa.

14. The method according to claim 13 with one example of said adjunct game program being a puzzle where if the user solves a problem, the permission rule allows the continued use of the soft-phone.

15. The method according to claim 13 with another example being after a user completes some portion of the addressing or preparation of a communications to a party via the soft-phone, the adjunct program automatically parses the information in a manner that allows its input to a casino game such as keno, roulette, or slot machine which is then executed, with the winning results awarded to the user in a plurality of ways.

16. The method according to claim 14 with another example being after receiving a communication from an adjunct program source, such as an alarm signal from a security or environmental monitoring system, whereby the soft-phone automatically completes the communications according to the set of rules for the source.
